(19) United States
(12) Patent Application Publication
(10) Pub. No.: US 2026/0221468 A1
(43) Pub. Date: Jul. 30, 2026

(54) METHODS FOR MANUFACTURING ELECTRODES

(71) Applicant: Toyota Motor Engineering & Manufacturing North America, Inc., Plano, TX (US)

(72) Inventors: Honghong Lin, Ann Arbor, MI (US); Gaohua Zhu, Ann Arbor, MI (US); Bjorn Hasa, Ann Arbor, MI (US); Wenxiao Deng, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/037,996

(22) Filed: Jan. 27, 2025

(51) Int. Cl. H01M 4/92; H01M 4/88

(52) U.S. Cl. CPC H01M 4/926; H01M 4/8882

(57) ABSTRACT

A method includes forming a wet electrode by mixing Pt-based/C catalyst nanoparticles with a surface modification agent such that a passivating layer is formed on surfaces of Pt-based nanoparticles of the Pt-based/C catalyst nanoparticles, and mixing the passivated Pt-based/C catalyst nanoparticles with an ionomer. The method also includes drying the wet electrode to form a dry electrode, and electrochemically cycling the dry electrode such that the passivating layer is removed from the surfaces of the Pt-based/C nanoparticles of the dry electrode and a clean dry electrode is formed. Also, the clean dry electrode is assembled into a HC-PEM fuel cell.

### TECHNICAL FIELD

The present disclosure generally relates to electrodes, and particularly to methods for manufacturing electrodes.

### BACKGROUND

Fuel cells with polymer electrolyte membranes (PEMs) are used as energy sources for transportation due to their high-power density, low operation temperatures, and zero emission of harmful gases.

In addition, non-fluorinated hydrocarbon polymer exchange membrane (HC-PEM) fuel cells have been developed to replace conventional PEM fuel cells that use perfluorinated sulfonic acid polymers (PFSAs). However, the performance of HC-PEM fuel cells underperforms conventional PEM fuel cells due to ionomer poisoning of the anode and/or cathode catalyst layer.

The present disclosure addresses the issue of poisoning of anode and/or cathode catalyst materials of HC-PEM fuel cells, and other issues related to HC-PEM fuel cells.

### SUMMARY

In one form of the present disclosure, a method includes forming a wet electrode by mixing Pt-based/C catalyst nanoparticles with a surface modification agent such that a passivating layer is formed on surfaces of Pt-based nanoparticles of the Pt-based/C catalyst nanoparticles, and mixing the passivated Pt-based/C catalyst nanoparticles with an ionomer. The wet electrode is dried to form a dry electrode, and the dry electrode is electrochemically cycled such that the passivating layer is removed from the surfaces of the Pt-based/C nanoparticles of the dry electrode and a clean dry electrode is formed. Also, the clean dry electrode is assembled into a HC-PEM fuel cell.

In another form of the present disclosure, a method includes mixing Pt-based/C catalyst nanoparticles with a surface modification agent selected from carbon monoxide, alkylamine, alkyl carboxylic acid, and combinations thereof. The surface modification agent forms a passivating layer on surfaces of Pt-based nanoparticles of the Pt-based/C nanoparticles and the passivated Pt-base/C nanoparticles are mixed with an ionomer to form a catalyst ink. The catalyst ink is applied to an electrode substrate to form a wet electrode, the wet electrode is dried to form a dry electrode, and the dry electrode is subjected to electrochemically cycling such that the passivating layer on the surfaces of the Pt-based nanoparticles is removed and a clean dry electrode is formed. Also, the clean dry electrode is assembled into a fuel cell.

These and other features of the fuel cells will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1A illustrates a non-fluorinated hydrocarbon polymer exchange membrane fuel cells according to the teachings of the present disclosure;

FIG. 1B illustrates an enlarged view of an interface section labeled 1B in FIG. 1A with poisoned Pt-based nanoparticles;

FIG. 1C illustrates a backbone of an ionomer molecule absorbed on the surface of a Pt-based nanoparticle shown in FIG. 1B;

FIG. 1D illustrates an acid anion adsorbed on the surface on the surface of a Pt-based nanoparticle shown in FIG. 1B;

FIG. 2 illustrates an enlarged view of an interface section labeled 1B in FIG. 1A with clean Pt-based nanoparticles;

FIG. 3A illustrates a step for manufacturing an electrode with clean Pt-based nanoparticles according to the teachings of the present disclosure;

FIG. 3B illustrates another step for manufacturing an electrode with clean Pt-based nanoparticles according to the teachings of the present disclosure;

FIG. 3C illustrates still another step for manufacturing an electrode according to the teachings of the present disclosure;

FIG. 3D illustrates a passivated surface on a Pt-based nanoparticle blocking absorption of a backbone of an ionomer molecule onto the Pt-based nanoparticle;

FIG. 3E illustrates a passivated surface on a Pt-based nanoparticle blocking absorption of an acid anion onto the Pt-based nanoparticle;

FIG. 3F illustrates yet another step for manufacturing an electrode according to the teachings of the present disclosure;

FIG. 3G illustrates still yet another step for manufacturing an electrode according to the teachings of the present disclosure;

FIG. 3H illustrates a step for manufacturing an electrode according to the teachings of the present disclosure;

FIG. 3I illustrates a clean dry electrode manufactured according to one more the steps illustrated in FIGS. 3A-3C and 3F-3H;

FIG. 4 is a flow chart for a method of manufacturing an electrode according to the teachings of the present disclosure; and

FIG. 5 is a flow chart for a method of manufacturing a fuel cell according to the teachings of the present disclosure.

It should be noted that the figures set forth herein is intended to exemplify the general characteristics of the methods, and devices among those of the present technology, for the purpose of the description of certain aspects. The figure may not precisely reflect the characteristics of any given aspect and are not necessarily intended to define or limit specific forms or variations within the scope of this technology.

### DETAILED DESCRIPTION

Ionomer poisoning of platinum (Pt) based (Pt-based) catalysts suppresses the activity of the oxygen reduction reaction (ORR) in non-fluorinated hydrocarbon polymer exchange membrane fuel cells (HC-PEM) fuel cells (also known as fully hydrocarbon polymer exchange membrane fuel cells) operating at temperatures between about 60° C. and about 90° C. Not being bound by theory, the poisoning is due to adsorption of an ionomer on the Pt surface (ionomer poisoning) of Pt-based catalysts, i.e., ionomer poisoning can be caused by acid anion adsorption and/or ionomer backbone adsorption on the Pt surfaces. That is, absorption of ionomer species onto surfaces of Pt-based nanoparticles decreases the number of available catalytic active sites on the Pt-based nanoparticles such that performance of the HC-PEM fuel cell is compromised.

The present disclosure provides an electrode with a Pt-based catalyst material (also referred to herein simply as “Pt-based catalyst”) with surfaces that have been cleaned, particularly surfaces of Pt-based nanoparticles that have been cleaned (referred to herein simply as “clean Pt-based nanoparticles”). As used herein, the phrases “clean Pt-based nanoparticles” and “clean Pt-based/C nanoparticles” refer to nanoparticles with Pt-based nanoparticle surfaces that have been passivated with a surface modification agent (SMA) such that ionomer molecules are inhibited or prevented from absorbing onto the Pt-based nanoparticle surfaces, and then electrochemically cycled such that the SMA is removed from the Pt-based nanoparticle surfaces. In this manner, electrodes for fuel cells manufactured according to the teachings of the present disclosure exhibit enhanced performance due to a reduction or prevention of ionomer poisoning of Pt-based nanoparticles. And as used herein, the phrase “clean dry electrode” refers to an electrode having clean Pt-based nanoparticles and/or clean Pt-based/C nanoparticles.

The Pt-based catalyst can include Pt-based nanoparticles supported on a carbon support (referred to herein as “Pt-based/C nanoparticles), the carbon support having a surface area greater than 200 meters squared per gram of carbon (200 m²/g). Also, the Pt-based nanoparticles can have an average diameter between about 1 nanometer (nm) and about 20 nm, e.g., between about 2 nm and about 10 nm, and can be nanoparticles of PtM1, PtM1M2, PtM1M2M3, PtM1M2M3M4, and PtM1M2M3M4M5, where M1, M2, M3, M4, M5 are selected from Ti, V, Cr, Mn, Fe, Co, Ni, Cu, Zn, Ga, Pd, Ag, Ru, Ir, Ag, Au, and N, among others. In some variations, the Pt-based nanoparticles are core-shell nanoparticles with a Pd core, a Pt core, or a Pd-Pt core, among others, and a shell of PtM1, PtM1M2, PtM1M2M3, PtM1M2M3M4, or PtM1M2M3M4M5 as described above.

In at least one variation, the carbon support is in the form of carbon particles. In some variations, the carbon particles have an average diameter between about 50 nm and about 1000 nm, e.g., between about 50 nm and about 100 nm, between about 100 nm and about 200 nm, between about 200 nm and about 300 nm, between about 300 nm and about 400 nm, between about 400 nm and about 500 nm, between about 500 nm and about 600 nm, between about 600 nm and about 700 nm, between about 700 nm and about 800 nm, between about 800 nm and about 900 nm, or between about 900 nm and about 1000 nm. And in some variations the carbon particles are porous. In variations where the carbon particles are porous, the Pt-based nanoparticles may or may not be positioned within pores of the porous carbon nanoparticles.

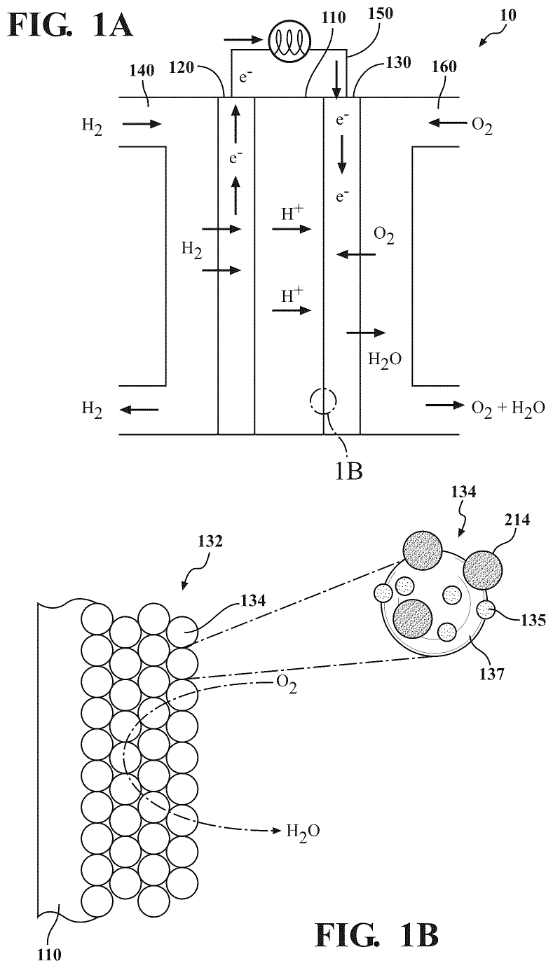

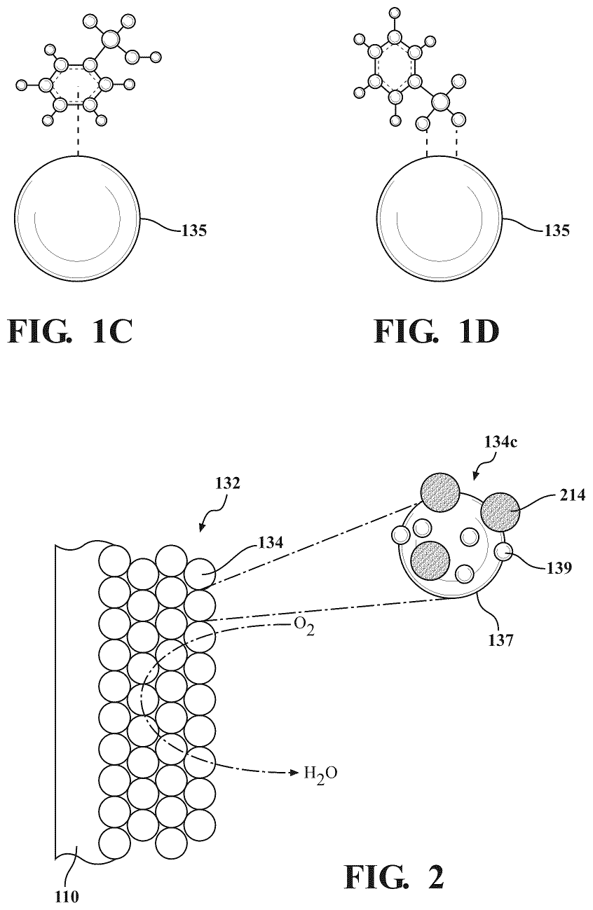

Referring now to FIG. 1A, a HC-PEM fuel cell 10 is shown. The HC-PEM fuel cell 10 includes a non-fluorinate PEM 110 sandwiched between an anode 120 and a cathode 130, a sulfonated hydrocarbon polymer electrolyte 112, and an external electrical circuit 150 that electrically connects the anode 120 and the cathode 130. The cathode 130 includes a catalyst layer 132 with a plurality of Pt-based nanoparticles 135 supported on a carbon support (particles) 137 (collectively referred to herein as Pt-based/C nanoparticles 134) and ionomer molecules 214 absorbed on the carbon support 137 as illustrated in FIG. 1B. It should be understood that while FIG. 1B illustrates the ionomer molecules 214 as droplets absorbed onto the carbon particles 137, it should be understood that the ionomer molecules 214 can be present as a film or layer on the carbon particles 137. In addition, and as illustrated in FIGS. 1C-1D, the surfaces of the Pt-based nanoparticles 135 also have ionomer molecules 214 absorbed thereon. For example, and assuming phenyl functional groups of part of the ionomer molecules 214, the backbone of phenyl molecules can be absorbed onto the Pt-based nanoparticles 135 (FIG. 1C) and/or phenyl acid anions can be absorbed onto the Pt-based nanoparticles 135 (FIG. 1D).

During operation of the HC-PEM fuel cell 10, hydrogen (H₂) gas is provided to and flows through an anode-side inlet 140 and oxygen (O₂) gas (e.g., O₂ in air) is provided to and flows through a cathode-side inlet 160. At least a portion of the H₂ flows into contact with the anode 120 and migrates to the PEM 110 where H₂ molecules are catalyzed into H⁺ions plus electrons ‘e⁻’ (e.g., via an anode catalyst layer—not shown). Also, at least a portion of the O₂ gas flows into contact with the cathode and migrates to the PEM 110. The electrons e⁻ flow through the external electrical circuit 150 to the cathode 130 and react with O₂ molecules to form O²⁻ ions (e.g., via the catalyst layer 132) and the H⁺ ions diffuse through the PEM 110 to the cathode 130 and react with the O²⁻ ions to form H₂O (water), which is then transported out of the HC-PEM fuel cell 10 with the flow of unreacted O₂. In this manner, the catalyst nanoparticles 134 assist in and enhance the reaction of O₂+e⁻ to O²⁻ and/or O²⁻+H⁺ to H₂O and electricity is generated by the HC-PEM fuel cell 10. However, and given that the surfaces of the Pt-based nanoparticles 135 have ionomer molecules 214 absorbed thereon (i.e., are poisoned), active sites on the catalytic Pt-based nanoparticles 135 are reduced such that the performance of the catalyst layer 132 and thus the HC-PEM fuel cell 10 are compromised, i.e., operate at less than desired efficiency.

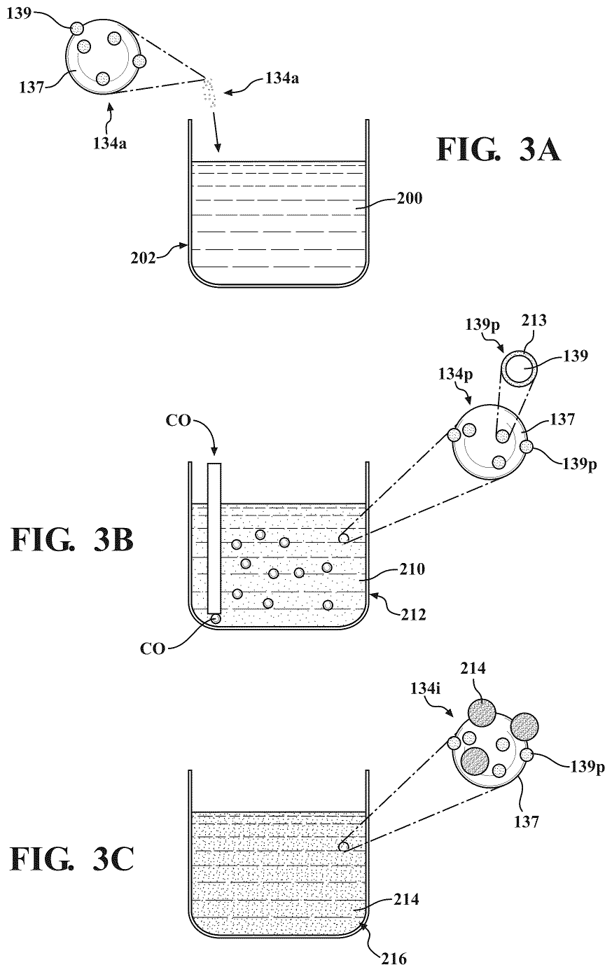

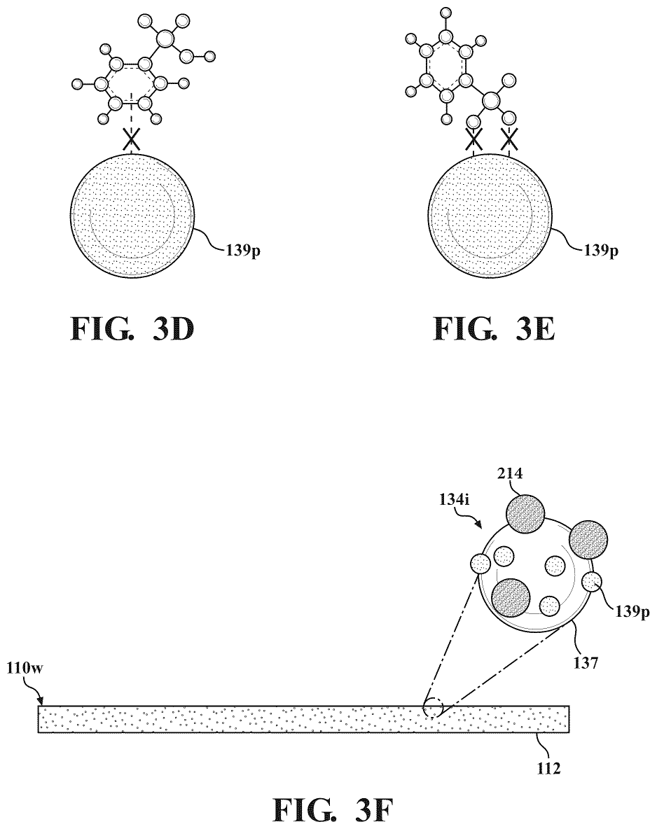

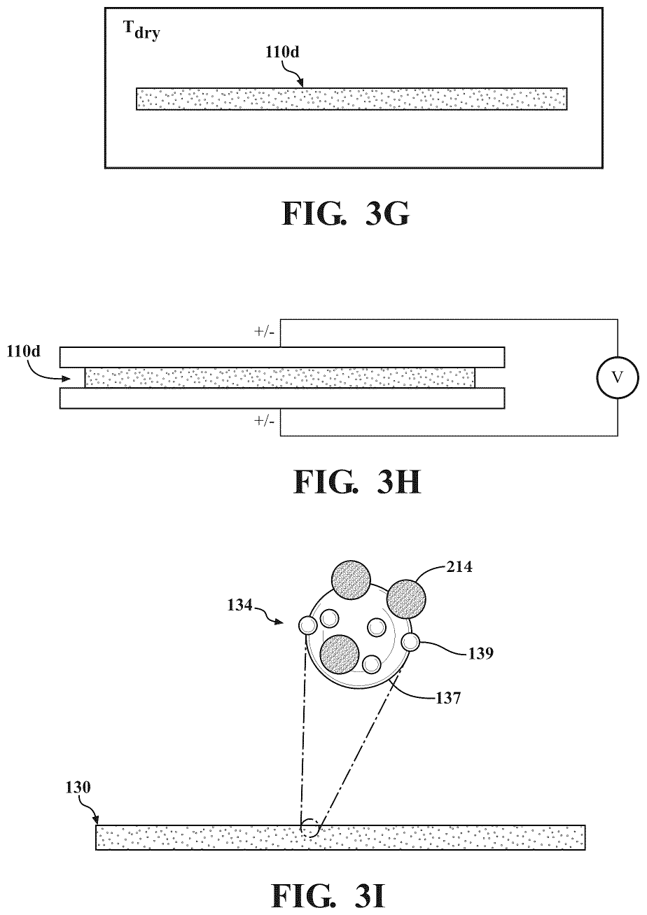

Referring to FIG. 2, the present disclosure provides a catalyst layer with 132 with a plurality of Pt-based/C nanoparticles 134c and ionomer molecules disposed on supported on the carbon particles 137. However, and unliked the plurality of Pt-based/C nanoparticles 134 illustrated in FIG. 1B, the Pt-based/C nanoparticles 134c have or include clean Pt-based nanoparticles 139. Accordingly, the catalyst layer 132 is a clean catalyst layer and the cathode 130 is a clean cathode. And with reference to FIGS. 3A-3G, steps for the manufacture of the cathode electrode (cathode) 130 with the clean Pt-based/C nanoparticles 134c are illustrated.

Referring to FIG. 3A, Pt-based/C nanoparticles 134a with clean Pt-based nanoparticles 139 supported on the carbon particles 137 are added to and mixed with a solvent 200 to form a Pt-based/C nanoparticle—solvent mixture 202. In some variations, the solvent 200 includes water and alcohol, water and dimethyl sulfoxide (DMSO), water/1-propanol (water/NPA), water and ethylene glycol (EG), water and N-methylformamide (NMF), water and dimethylformamide (DMF), water and dimethylacetamide (DMAc), water and N-Methylpyrrolidone (NMP), and combinations/mixtures thereof. And with reference to FIG. 3B, a SMA 210 is added to and mixed with the Pt-based/C nanoparticle - solvent mixture 202 to form a Pt-based/C nanoparticle—SMA solution 212. In some variations, the SMA 210 is at least one of carbon monoxide (CO), an alkylamine (e.g., oleylamine (C₁₈H₃₇N), CₙH₍₂ₙ₊₃₎N, CₙH₍₂ₙ₊₁₎ N (where 1<n<20), among others), and an alkyl carboxylic acid (e.g., oleic acid (C₁₈H₃₄O₂), CₙH₍₂ₙ₋₂₎O₂, CₙH₍₂ₙ₎O₂ (where 1<n<20), among others). And not being bound by theory, the SMA 210 forms a passivation layer 213 on the surfaces of the clean Pt-based nanoparticles 139 such that Pt-based/C nanoparticles 134p with passivated Pt-based nanoparticles 139p are formed.

Referring to FIG. 3C, an ionomer 214 is added to and mixed with the Pt-based/C nanoparticle - SMA solution 212 to form a catalyst ink 216. Non-limiting examples of the ionomer 214 include sulfonated poly(etherketones), sulfonated polysulfones, sulfonated poly(ethersulfones), sulfonated polyimides, sulfonated polybenzimidazoles, and sulfonated polyphosphazene, among others. Molecules of the ionomer 214 are absorbed onto the carbon support particles 137 such that Pt-based/C nanoparticles 134i are formed. However, the passivation layer 213 on the passivated Pt-cased nanoparticles 139p repels and/or prevents absorption of the ionomer molecules 214 onto the passivated Pt-cased nanoparticles 139p as illustrated in FIGS. 3D-3E. Stated differently, and as illustrated in FIG. 3C, ionomer molecules 214 are selectively absorbed onto the carbon particles 137.

Referring to FIG. 3F, a wet electrode 110w is formed using the catalyst ink 216. In some variations, the catalyst ink 216 is applied to a porous substrate 112 (e.g., a porous carbon paper substrate) such that the porous substrate 112 is infused with Pt-based/C nanoparticles 134i. Techniques for applying the catalyst ink 216 to the porous substrate include painting the porous substrate 112 with the catalyst ink 216, printing the catalyst ink 216 onto the porous substrate 112, and dipping or immersing the porous substrate 112 into the catalyst ink 216, among others. In this manner, a high surface area layer for the O₂+e⁻ to O²⁻ and/or O²⁻+H⁺ to H₂O reactions is provided.

Referring to FIG. 3G, the wet electrode 110w is dried at a drying temperature T_{dry} to remove most if not all of the solvent 200 such that a dry electrode 110d is formed. In some variations the drying temperature is between about 20° C. and about 60° C. Also, the wet electrode 110w may or may not be dried in a low oxygen or reducing gas atmosphere. For example, in some variations the wet electrode 110w is dried in air, while in other variations the wet electrode 110w is dried in N₂.

After the dry electrode 110d is formed, and with reference to FIG. 3H, the dry electrode 110d, and thus the Pt-based/C nanoparticles 134i, is/are subjected to electrochemically cycling. In some variations, the dry electrode 110d, and thus the Pt-based/C nanoparticles 134i, are electrochemically cycled between about 0.0 volts (V) and about 1.6 V. For example, in one variation the dry electrode 110d, and thus the Pt-based/C nanoparticles 134i, are electrochemically cycled between about 0.0 volts (V) and about 1.2 V.

The electrochemical cycling removes the passivation layer 213 (FIG. 3B) from the passivated Pt-based nanoparticles 139p such that the passivated Pt-based nanoparticles 139p are returned or synthesized to clean Pt-based nanoparticles 139 as illustrated in FIG. 3I and a clean cathode 130 is formed. For example, in variations where the SMA 210 include CO, the CO is oxidized to CO₂ that is not absorbed to surfaces of the Pt-based nanoparticles 139. Also, in variations where the SMA 210 includes an alkylamine, the alkylamine is oxidized to form a free amine that is not absorbed on the surfaces of the Pt-based nanoparticles 139. And in variations where the SMA 210 includes an alkyl carboxylic acid, the alkyl carboxylic acid is oxidized to form a free acid that is not absorbed on the surfaces of the Pt-based nanoparticles 139.

In some variations, the clean cathode 130 is bonded to a gas diffusion layer such that an electrode assembly is formed (not shown). It should be understood that the ionomer molecules function as a binder that holds the Pt-based/C nanoparticles 134 together and forms a network of pathways for protons to travel through the catalyst layer 132.

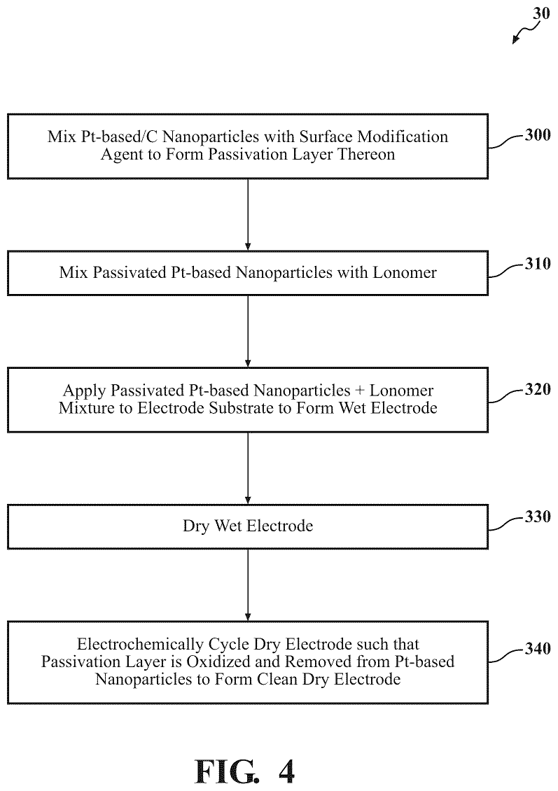

Referring to FIG. 4, a method 30 for fabricating a clean electrode according to the teachings of the present disclosure is shown. The method 30 includes mixing Pt-based/C nanoparticles with a surface modification agent such that a passivation layer is formed on surfaces of the Pt-based nanoparticles of the Pt-based/C nanoparticles at 300, and mixing the passivated Pt-based/C nanoparticles with an ionomer at 310. The passivated Pt-based/C nanoparticles+ionomer mixture is applied to an electrode substrate at 320 such that a wet electrode is formed, and the wet electrode is dried at 330 to from a dry electrode. Then, the dry electrode is subject to electrochemically cycles at 340 such that the passivation layer on the Pt-based/C nanoparticles is removed from the surfaces thereof and clean Pt-based nanoparticle surfaces and a clean dry electrode are provided.

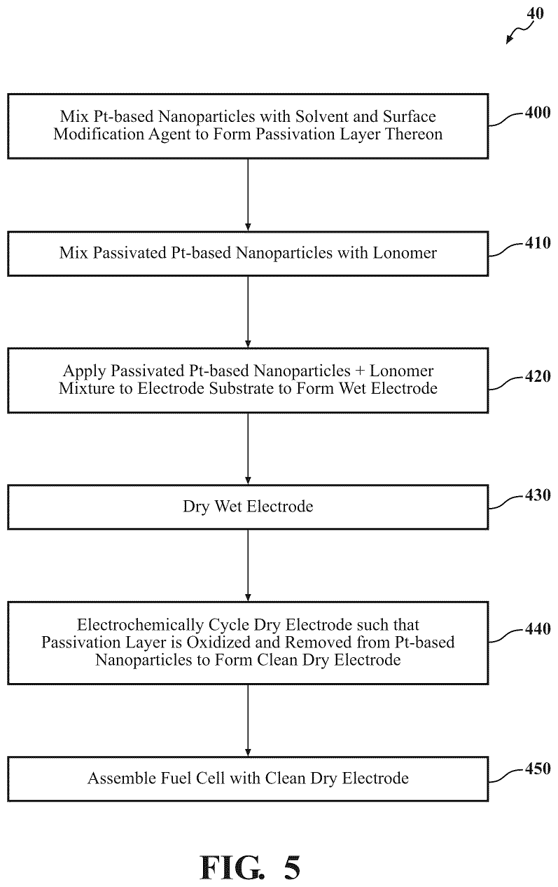

Referring to FIG. 5, a method 40 for fabricating a HC-PEM fuel cell according to the teachings of the present disclosure is shown. The method 40 includes mixing Pt-based/C nanoparticles with a surface modification agent such that a passivation layer is formed on surfaces of the Pt-based nanoparticles of the Pt-based/C nanoparticles at 400 and mixing the passivated Pt-based/C nanoparticles with an ionomer at 410. The passivated Pt-based/C nanoparticles+ionomer mixture is applied to an electrode substrate at 420 such that a wet electrode is formed, and the wet electrode is dried at 430 to from a dry electrode. The dry electrode is subject to electrochemically cycles at 440 such that the passivation layer on the Pt-based/C nanoparticles is removed from the surfaces thereof and clean Pt-based nanoparticle surfaces and a clean dry electrode are provided. Then, an HC-PEM fuel cell is assembled using the clean dry electrode at 450.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A method comprising:
forming a wet electrode comprising mixing Pt-based/C nanoparticles with a surface modification agent and an ionomer, the Pt-based/C nanoparticles comprising Pt-based nanoparticles supported on carbon particles and the surface modification agent forms a passivating layer on the Pt-based nanoparticles;
drying the wet electrode and forming a dry electrode;
electrochemically cycling the dry electrode such that the passivating layer is removed from the Pt-based nanoparticles of the dry electrode and a clean dry electrode is formed; and
assembling the clean dry electrode into a fuel cell.

2. The method according to claim 1, wherein the surface modification agent is selected from carbon monoxide, alkylamine, alkyl carboxylic acid, and combinations thereof.

3. The method according to claim 1, wherein the surface modification agent comprises carbon monoxide (CO).

4. The method according to claim 3, wherein the CO is absorbed onto a surface of the Pt-based nanoparticles before electrochemically cycling the dry electrode and electrochemically cycling the dry electrode oxidizes the CO to CO₂ such that the CO is removed from the surface of the Pt-based/C nanoparticles.

5. The method according to claim 1, wherein the surface modification agent comprises alkylamine.

6. The method according to claim 5, wherein the alkylamine is absorbed to a surface of the Pt-based nanoparticles before electrochemically cycling the dry electrode and electrochemically cycling the dry electrode oxidizes the alkylamine to form a free amine such that the alkylamine is removed from the surface of the Pt-based nanoparticles.

7. The method according to claim 1, wherein the surface modification agent comprises alkyl carboxylic acid.

8. The method according to claim 7, wherein the alkyl carboxylic acid is absorbed onto a surface of the Pt-based nanoparticles before electrochemically cycling the dry electrode and electrochemically cycling the dry electrode oxidizes the alkyl carboxylic acid to form a free acid such that the alkyl carboxylic acid is removed from the surface of the Pt-based nanoparticles.

9. The method according to claim 1, wherein the ionomer is selected from the group consisting of sulfonated poly(etherketones), sulfonated polysulfones, sulfonated poly(ethersulfones), sulfonated polyimides, sulfonated polybenzimidazoles, sulfonated polyphosphazene, and combinations thereof.

10. The method according to claim 1, wherein the electrochemically cycling the dry electrode comprises electrochemically cycling between about 0.0 V and 1.6 V.

11. The method according to claim 1, wherein the electrochemically cycling the dry electrode comprises electrochemically cycling between about 0.0 V and 1.2 V.

12. The method according to claim 1, wherein the carbon have a surface area greater than 200 m²/g and the Pt-based nanoparticles are selected from the group consisting of PtM1, PtM1M2, PtM1M2M3, PtM1M2M3M4, and PtM1M2M3M4M5, where M1, M2, M3, M4, M5 are selected from the group consisting of Ti, V, Cr, Mn, Fe, Co, Ni, Cu, Zn, Ga, Pd, Ag, Ru, Ir, Ag, Au, and N.

13. The method according to claim 1, wherein the wet electrode is dried within a temperature range between about 20° C. and 60° C.

14. The method according to claim 1, wherein forming the wet electrode further comprises dispersing the Pt-based/C nanoparticles in a solvent comprising a mixture of a water, alcohol, and the surface modification agent forms the passivating layer on the Pt-based nanoparticles prior to mixing the passivated Pt-based/C nanoparticles with the ionomer.

15. A method comprising:
forming a wet electrode comprising mixing Pt-based/C nanoparticles with a surface modification agent selected from the group consisting of carbon monoxide, alkylamine, alkyl carboxylic acid, and combinations thereof, the Pt-based/C nanoparticles comprising Pt-based nanoparticles supported on carbon particles and the surface modification agent forms a passivating layer on the Pt-based nanoparticles;
mixing the passivated Pt-based nanoparticles with an ionomer;
drying the wet electrode and forming a dry electrode;
electrochemically cycling the dry electrode such that the passivating layer is removed from the Pt-based nanoparticles of the dry electrode and a clean dry electrode is formed; and
assembling the clean dry electrode into a fuel cell.

16. The method according to claim 15, wherein the surface modification agent comprises carbon monoxide (CO).

17. The method according to claim 16, wherein the CO is bonded to a surface of the Pt-based nanoparticles before electrochemically cycling the dry electrode and electrochemically cycling the dry electrode oxidizes the CO to CO₂ such that the CO is removed from the surface of the Pt-based nanoparticles.

18. The method according to claim 15, wherein the surface modification agent comprises alkylamine.

19. The method according to claim 18, wherein the alkylamine is bonded to a surface of the Pt-based nanoparticles before electrochemically cycling the dry electrode and electrochemically cycling the dry electrode oxidizes the alkylamine to form a free amine such that the alkylamine is removed from the surface of the Pt-based nanoparticles.

20. The method according to claim 15, wherein the surface modification agent comprises alkyl carboxylic acid, the alkyl carboxylic acid is bonded to a surface of the Pt-based nanoparticles before electrochemically cycling the dry electrode, and electrochemically cycling the dry electrode oxidizes the alkyl carboxylic acid to form a free acid such that the alkyl carboxylic acid is removed from the surface of the Pt-based nanoparticles.
